(19) United States
(12) Patent Application Publication
(10) Pub. No.: US 2026/0215881 A1
(43) Pub. Date: Jul. 30, 2026

(54) DENTAL ROOT CANAL TREATMENT INSTRUMENT

(71) Applicant: JUN DENTAL.CO, Daegu (KR)

(72) Inventor: Joon Chol PARK, Daegu (KR)

(73) Assignee: JUN DENTAL.CO, Daegu (KR)

(21) Appl. No.: 19/146,531

(22) PCT Filed: Nov. 8, 2023
(86) PCT No.: PCT/KR2023/017841

§ 371 Date: Jul. 9, 2025

(30) Foreign Application Priority Data
Nov. 9, 2022 (KR) 10-2022-0148789

(51) Int. Cl. A61C 5/44; A61C 5/42

(52) U.S. Cl. CPC A61C 5/44; A61C 5/42

(57) ABSTRACT

Provided is a dental root canal treatment instrument including: an insertion part which extends in a length direction, is equipped with a clearing blade, and is inserted into a root canal; and a safe band part which is provided on one side of the insertion part, is wider than the insertion part, and is not equipped with a clearing blade, wherein the safe band part contacts the inner wall of the root canal while not cutting the root canal.

### TECHNICAL FIELD

The present disclosure relates to a dental root canal treatment instrument, and more particularly, to a dental root canal treatment instrument capable of preventing an insertion part from being too deeply inserted by limiting an entry depth of the insertion part entering the root canal by means of a safe band part provided at one side of the insertion part having a clearing blade.

### BACKGROUND ART

Root canal treatment is a treatment known as nerve therapy during dental treatment. Referring to FIG. 1, a tooth 10 may be separated into a crown 11 and a root 12. The crown 11 corresponds to an upper portion of the tooth 10 and protrudes from the gum. The root 12 is provided at a lower portion of the crown 11 and is inserted into the gum, and the root 12 is connected to the alveolar bone.

Referring to FIG. 1, a root canal 20 is a small empty space formed inside the root 12. Pain may occur when a lesion occurs, for example, when bacteria invades the root canal 20. The root canal treatment is a method of treating lesions that have occurred inside the root canal 20. The root canal treatment method is a treatment for mechanically cleaning, shaping, and closing the inside of the root canal 20.

The treatment instrument for root canal therapy is a file for mechanically cleaning and shaping the inside of the root canal 20. The file is a rod-shaped treatment instrument that extends in its longitudinal direction.

Recently, files may be installed and used in electric devices, and such electric files play a major role in improving the cutting efficiency due to their widespread use. However, such files have the following problems.

When cutting the inside of the root canal 20 by using the file, there is a problem in that it is difficult to adjust the depth of entry of the file into the root canal 20. When entering the file into the root canal 20, both a deeper or shorter entry depth of the file than the length of the root canal 20 may be a significant problem that may lead to treatment failure.

The conventional file does not have a separate device to adjust the depth of the file entering the root canal 20, thus relying on the skill of the dentist.

### SUMMARY

### Technical Problem

In order to solve the conventional problems, the present disclosure relates to a dental root canal treatment instrument, and more particularly, to a dental root canal treatment instrument capable of preventing an insertion part from being too deeply inserted by limiting an entry depth of the insertion part entering the root canal by means of a safe band part provided at one side of the insertion part having a clearing blade.

### Technical Solution

According to an aspect of the present disclosure, there is provided a dental root canal treatment instrument including an insertion part extending in a longitudinal direction and being inserted into a root canal along with a clearing blade as a treatment instrument used for root canal treatment by entering the root canal, and a safe band part provided on one side of the insertion part, having a width greater than the width of the insertion part, and having no clearing blade, wherein the safe band part comes in contact with an inner wall of the root canal without cutting the root canal.

A cross-section of the insertion part may have a polygonal shape, and a cross-section of the safe band part may have a circular shape.

The insertion part and the safe band part may be integrally manufactured.

The safe band part may be slidably movable with respect to the insertion part.

The insertion part and the safe band part may include a same material and be integrally manufactured.

The insertion part may have a narrower width from one end to another end, the safe band part may have a width greater than a width of the one end of the insertion part, and a tapered slope may be formed outside the safe band part.

The dental root canal treatment instrument may further include a buffer part connecting the insertion part and the safe band part to each other, and the buffer part may include a cross-section part extending in a flat surface shape.

The insertion part, the safe band part, and the buffer part may be integrally manufactured, and the insertion part, the safe band part, and the buffer part may be manufactured through laser processing.

The dental root canal treatment instrument may further include an extension part provided at one side of the safe band part and extending in a longitudinal direction, and a coupling part connected to the extension part and coupled to an electric mechanism.

### Advantageous Effects

The present disclosure relates to a dental root canal treatment instrument, which has the advantage of limiting the depth of entry of the insertion part entering the root canal by providing a safe band part on one side of the insertion part equipped with a clearing blade.

The present disclosure has the advantage of preventing the insertion part from entering the root canal deeper than an operator's intention by limiting the depth of entry of the insertion part through the safe band part.

The present disclosure has the advantage of increasing the efficiency of root canal treatment and increasing the success rate by preventing, through the safe band part, the insertion part from entering the root canal deeper than an operator's intention and failure of treatment.

### BRIEF DESCRIPTION OF THE DRAWINGS

FIG. 1 is a diagram showing a tooth consisting of a crown and a root.

FIG. 2 is a perspective view of a dental root canal treatment instrument according to an embodiment of the present disclosure.

FIG. 3 is a side view of a dental root canal treatment instrument according to an embodiment of the present disclosure.

FIG. 4 is a cross-sectional view of an insertion part according to an embodiment of the present disclosure.

FIG. 5 is a perspective view illustrating an insertion part, a buffer part, and a safe band part of a dental root canal treatment instrument according to an embodiment of the present disclosure.

FIGS. 6 to 8 are views illustrating a process of mechanically removing a lesion inside the root canal through a dental root canal treatment instrument according to an embodiment of the present disclosure.

FIG. 9 is a view illustrating that the safe band part is slidably movable with respect to the insertion part according to another embodiment of the present disclosure.

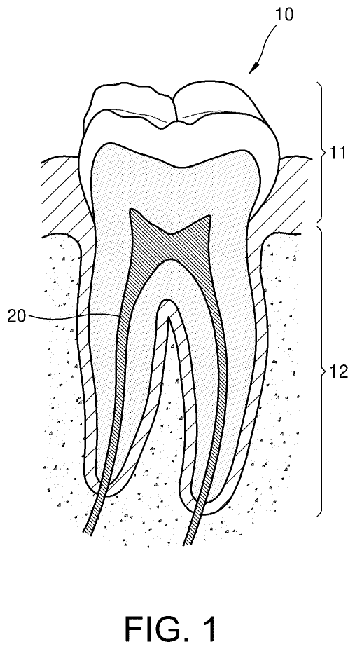

### DESCRIPTION OF THE EMBODIMENTS

The disclosure will be described more fully hereinafter with reference to the accompanying drawings, in which embodiments according to the inventive concept are shown, and the principle of the inventive concept is described so that the embodiments may be practiced by those skilled in the art. The disclosed embodiments may be implemented in various forms.

Expressions such as “including” or “may include” that may be used in various embodiments of the inventive concept indicate the existence of a corresponding function, operation, component, or the like that is disclosed, and do not limit one or more additional functions, operations, components, or the like. In addition, in various embodiments according to the inventive concept, terms such as “comprises,” “has,” or “consists of” are intended to refer to the presence of features, numbers, steps, operations, components, parts, or combinations thereof described in the specification, but it should be understood that the terms do not preclude the existence or addition of one or more other features, numbers, steps, operations, components, parts, or combinations thereof.

When it is said that a component is “connected and coupled” to another component, it should be understood that said component may be directly connected or coupled to said other component, but that there may also be new other components between said component and said other component. In addition, when it is said that a component is “directly connected” or “directly coupled” to another component, it should be understood that no new component exists between said component and said other component.

The terms first, second, etc. used in the disclosure may be used to describe various components, but the components should not be limited by terms. The terms are used only for the purpose of distinguishing one component from other components.

The present disclosure relates to a dental root canal treatment instrument, and to a dental root canal treatment instrument capable of preventing an insertion part from being deeply inserted by limiting an entry depth of the insertion part entering the root canal by means of a safe band part which is provided at one side of the insertion part having a clearing blade.

A dental root canal treatment instrument according to an embodiment of the present disclosure may be a file inserted into a root canal 20. Hereinafter, preferred embodiments of the inventive concept are described in detail with reference to the accompanying drawings.

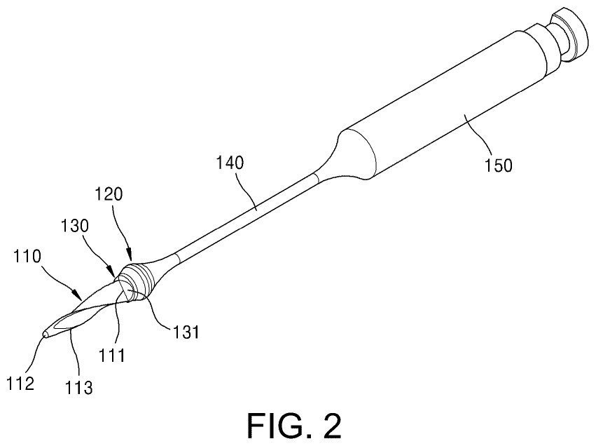

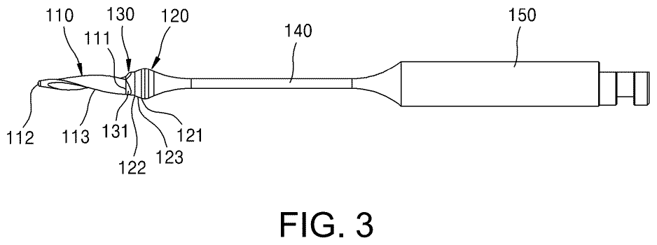

Referring to FIGS. 2 and 3, a dental root canal treatment instrument according to an embodiment of the present disclosure includes an insertion part 110 and a safe band part 120.

Referring to FIG. 2, the insertion part 110 extends in the longitudinal direction and is inserted into the root canal 20 while having a clearing blade 113. The insertion part 110 may have a rod shape, and the clearing blade 113 may be provided outside the rod-shaped insertion part 110.

The insertion part 110 may be rotated by an electric mechanism. When the insertion part 110 is inserted into the root canal 20 and the insertion part 110 is rotated by an electric mechanism, a lesion inside the root canal 20 may be mechanically removed through the clearing blade 113 of the insertion part 110.

According to an embodiment of the present disclosure, the clearing blade 113 of the insertion part 110 may be provided in the insertion part 110 formed in a rod shape while extending in a spiral shape, and a cross-section of the insertion part 110 may be formed in a polygonal shape.

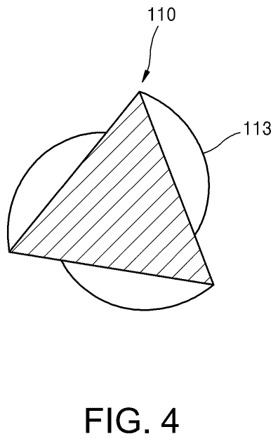

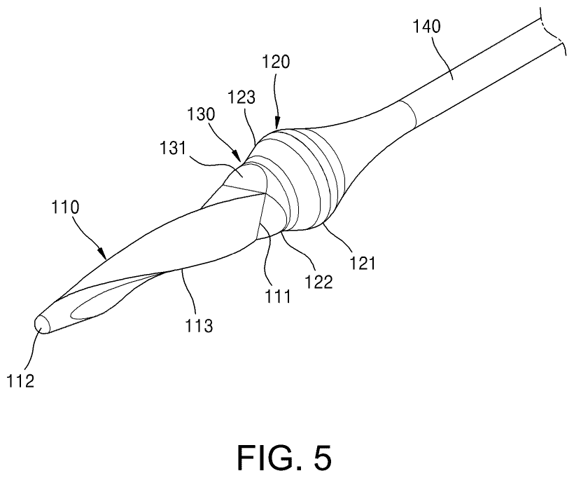

Referring to FIGS. 4 and 5, the clearing blade 113 according to an embodiment of the present disclosure may be formed through a vertex of the insertion part 110 having a triangular cross-section. Here, FIG. 4 is a diagram illustrating a cross-section of the insertion part 110 when viewed from one end 111 of the insertion part 110 toward the other end of the insertion part 110.

When the cross-section of the insertion part 110 formed of a triangle rotates in the length direction of the insertion part 110, the clearing blade 113 may extend in a spiral shape in the length direction of the insertion part 110 while the vertex of the triangle rotates.

More specifically, when the center angle of the cross-section of the insertion part 110 formed of a triangle changes and extends in the longitudinal direction of the insertion part 110, the clearing blade 113 may extend in a spiral shape in the longitudinal direction of the insertion part 110 while the vertex of the triangle rotates.

In this case, the cross-section of the insertion part 110 having a triangular shape may have a cross-sectional area that gradually decreases from one end 111 of the insertion part 110 to the other end 112 of the insertion part 110.

Here, the center angle of the cross-section of the insertion part 110 made of a triangle may be an angle formed by a line to be connected to the center of the triangle at one vertex of the triangle and a vertical line, and when the insertion part 110 extends in the longitudinal direction, the center angle of the cross-section of the insertion part 110 made of a triangle may change and extend.

However, the cross-section of the insertion part 110 according to an embodiment is not limited to a triangle, and may be formed in a polygonal shape such as a rectangle or a pentagon. The clearing blade 113 may be formed through a vertex of the insertion part 110 having a polygonal cross-section. When the cross-section of the insertion part 110 formed of a polygon rotates in the length direction of the insertion part 110, the clearing blade 113 may extend in a spiral shape in the length direction of the insertion part 110 while the vertex of the polygon rotates.

More specifically, when the center angle of the cross-section of the insertion part 110 formed of a polygon changes and extends in the longitudinal direction of the insertion part 110, the clearing blade 113 may extend in a spiral shape in the longitudinal direction of the insertion part 110 while the vertex of the polygon rotates.

In this case, the cross-section of the insertion part 110 having a polygonal shape may have a cross-sectional area that gradually decreases from one end 111 of the insertion part 110 to the other end 112 of the insertion part 110.

Here, the center angle of the cross-section of the insertion part 110 made of a polygon may be an angle formed by a line to be connected to the center of the polygon at one vertex of the polygon and a vertical line, and when the insertion part 110 extends in the longitudinal direction, the center angle of the cross-section of the insertion part 110 made of a polygon may change and extend.

The safe band part 120 is provided at one side of the insertion part 110, and has a width greater than a width of the insertion part 110, and no clearing blade 113 is provided on the safe band part 120. According to an embodiment of the present disclosure, the safe band part 120 is connected to the insertion part 110, and a cross-section of the safe band part 120 may be circular, and no clearing blade 113 may be provided on the safe band part 120.

The safe band part 120 may have a width greater than the maximum width of the insertion

part 110. Specifically, a cross-section of the insertion part 110 having a polygonal shape may have a cross-sectional area that gradually decreases from one end 111 of the insertion part 110 to the other end 112 of the insertion part 110, and the insertion part 110 has a maximum width at one end 111 of the insertion part 110. The safe band part 120 may be formed in a circular shape and have a width greater than the maximum width of the insertion part 110.

When the safe band part 120 is inserted into the root canal 20, the safe band part 120 may be in contact with the inner wall of the root canal 20 without cutting the inner wall of the root canal 20. When the safe band part 120 is in contact with the inner wall of the root canal 20, the safe band part 120 is stopped by the root canal 20, and the entry of the insertion part 110 connected to the safe band part 120 is restricted.

According to an embodiment of the present disclosure, the insertion part 110 may have a width which decreases from one end 111 to the other end 112, and the safe band part 120 may have a width greater than that of one end 111 of the insertion part 110 and a tapered slope 123 may be formed outside the safe band part 120.

As described above, a cross-section of the insertion part 110 having a polygonal shape may have a cross-sectional area that gradually decreases from one end 111 of the insertion part 110 to the other end 112 of the insertion part 110, and thus the insertion part 110 may have a width which decreases from one end 111 of the insertion part 110 to the other end 112 thereof.

The safe band part 120 may have a width greater than that of one end 111 of the insertion part 110, and the tapered slope 123 may be formed outside the safe band part 120.

Specifically, a cross-section of the safe band part 120 may be formed in a circular shape, and a cross-sectional area of one side 121 of the safe band part 120 may be greater than a cross-sectional area of the other side 122 of the safe band part 120.

Referring to FIG. 5, the safe band part 120 may have a circular cross-section and may gradually increase in cross-section from the other side 122 to one side 121 of the safe band part 120. Accordingly, a tapered slope 123 may be formed outside the safe band part 120.

As described above, the safe band part 120 may be stopped on the inner wall of the root canal 20 by being in contact with the inner wall of the root canal 20 without the clearing blade 113 provided. When the safe band part 120 is stopped on the inner wall of the root canal 20, a tapered slope 123 may be formed outside the safe band part 120 to prevent a mechanical force from being applied to the inner wall of the root canal 20 by the safe band part 120.

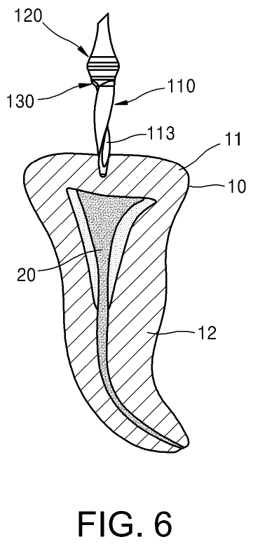

More specifically, referring to FIG. 6, the cross-sectional area of the root canal 20 may gradually decrease toward the alveolar bone. In consideration of the shape of the root canal 20, which gradually becomes small in cross-sectional area toward the alveolar bone, a tapered slope 123 may be formed outside the safe band part 120.

According to an embodiment of the present disclosure, the insertion part 110 and the safe band part 120 may be integrally manufactured. In addition, the insertion part 110 and the safe band part 120 may include the same material and may be integrally manufactured.

The insertion part 110 and the safe band part 120 may include a stainless steel material. However, embodiments are not limited thereto, and the insertion part 110 and the safe band part 120 may include a nickel-titanium alloy.

In addition, the insertion part 110 and the safe band part 120 may include different materials, and the insertion part 110 may include stainless steel, and the safe band part 120 may include a nickel-titanium alloy.

The insertion part 110 and the safe band part 120 according to an embodiment of the present disclosure may be manufactured through laser processing. The insertion part 110 and the safe band part 120 may be integrally manufactured through laser processing.

The dental root canal treatment instrument according to an embodiment of the present disclosure further include a buffer part 130. The buffer part 130 connects the insertion part 110 and the safe band part 120 to each other.

The buffer part 130 may be provided between one end 111 of the insertion part 110 and the other side 122 of the safe band part 120, and the insertion part 110 and the safe band part 120 may be connected to each other through the buffer part 130.

The buffer part 130 may be provided with a cross-sectional part 131 extending in a flat surface shape. The cross-sectional part 131 may be formed outside the buffer part 130, and the cross-sectional part 131 may be formed outside the buffer part 130 while extending in a flat surface shape.

As described above, a cross-section of the insertion part 110 may have a polygonal shape, and a cross-section of the safe band part 120 may have a circular shape. The cross-sectional part 131 of the buffer part 130 is provided to smoothly connect the insertion part 110 having a polygonal cross-section and the safe band part 120 having a circular cross-section to each other.

Specifically, the cross-sectional part 131 may extend from the side of a polygon formed by one end of the insertion part 110, and the buffer part 130 may be provided with the same number of cross-sectional parts 131 as the number of sides of the polygon.

Referring to FIG. 5, the cross-sectional part 131 according to an embodiment of the present disclosure may extend in a flat surface shape toward the other side 122 of the safe band part 120 forming a circular cross-section from three sides of a triangle formed by one end 111 of the insertion part 110.

In addition, the cross-sectional part 131 according to an embodiment of the present disclosure may extend in a flat surface shape toward the other side 122 of the safe band part 120 forming a circular cross-section from sides of a polygon formed by one end 111 of the insertion part 110.

When the insertion part 110 has a polygonal cross-section and the safe band part 120 has a circular cross-section, sharp points may occur at a connection point between the insertion part 110 and the safe band part 120. Specifically, when the cross-section is directly changed from a polygon to a circle, a sharp corner may be formed at an end point of the circular cross-section.

The cross-sectional part 131 of the buffer part 130 is provided to prevent this, and the insertion part 110 having a polygonal cross-section and the safe band part 120 having a circular cross-section may be smoothly connected to each other through the cross-sectional part 131 of the buffer part 130.

The insertion part 110, the safe band part 120, and the buffer part 130 according to an embodiment of the present disclosure may be integrally manufactured. In addition, the insertion part 110, the safe band part 120, and the buffer part 130 according to an embodiment of the present disclosure may include the same material, or may include different materials as necessary. The insertion part 110, the safe band part 120, and the buffer part 130 according to an

embodiment of the present disclosure may be manufactured through laser processing. However, embodiments are not limited thereto, and the insertion part 110, the safe band part 120, and the buffer part 130 may be manufactured by various methods.

Referring to FIGS. 2 and 3, the dental root canal treatment instrument according to an embodiment of the present disclosure may further include an extension part 140 and a coupling part 150.

The dental root canal treatment instrument according to an embodiment of the present disclosure may be a file which is used after being connected to an electric mechanism. When the dental root canal treatment instrument according to an embodiment of the present disclosure is connected to an electric mechanism, the insertion part 110 rotates by the electric mechanism to mechanically remove the lesion inside the root canal 20.

The coupling part 150 is a point coupled to the electric mechanism. When the dental root canal treatment instrument according to an embodiment of the present disclosure is coupled to the electric mechanism through the coupling part 150, the insertion part 110 may be rotated by receiving the power of the electric mechanism.

The extension part 140 may connect the coupling part 150 and the safe band part 120 to each other. The extension part 140 may be provided on one side of the safe band part 120 and may extend in the longitudinal direction.

The extension part 140 may have a rod shape and may extend in a longitudinal direction, and the extension part 140 may have a width less than that of the safe band part 120. The coupling part 150 may be connected to the extension part 140, and an electric mechanism may be coupled to the coupling part 150 connected to the extension part 140.

FIGS. 6 to 8 are views illustrating a process of mechanically cleaning and shaping a lesion inside the root canal through a dental root canal treatment instrument according to an embodiment of the present disclosure.

Referring to FIG. 6, in order to mechanically remove the lesion inside the root canal 20, the insertion part 110 enters the inside of the root canal 20. In this case, the insertion part 110 enters the root canal 20 while rotating by an electric mechanism.

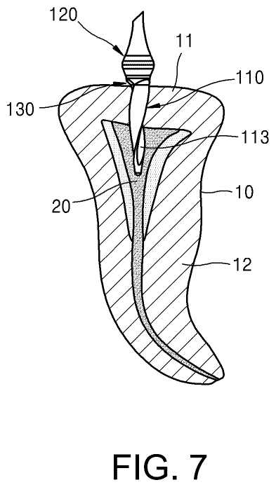

Referring to FIG. 7, when the insertion part 110 is inserted into the root canal 20 and the insertion part 110 is rotated by an electric mechanism, a lesion inside the root canal 20 may be mechanically removed through the clearing blade 113 of the insertion part 110.

In the treatment of the root canal 20, if the insertion part 110 is inserted deeper than the depth of the root canal 20, the treatment of the root canal 20 may fail. Conventionally, there was no separate device capable of adjusting the length of a file for root canal treatment, and thus the operation of the root canal treatment instrument was inevitably influenced by the skill level of the dentist.

However, the dental root canal treatment instrument according to an embodiment of the present disclosure limits the entry of the insertion part 110 by providing the safe band part 120 on one side of the insertion part 110, thereby preventing the insertion part 110 from entering the root canal 20 deeper than the dentist intended and leading to treatment failure.

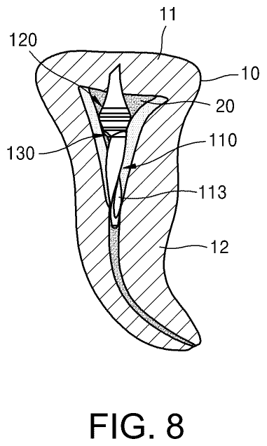

Specifically, referring to FIG. 8, the safe band part 120 may be in contact with the inner wall of the root canal 20 without cutting the inner wall of the root canal 20. If the safe band part 120 is in contact with the inner wall of the root canal 20, when the insertion part 110 is inserted into the root canal, the safe band part 120 is stopped by the root canal 20, so that the entry of the insertion part 110 connected to the safe band part 120 may be restricted.

Here, when the safe band part 120 is stopped on the inner wall of the root canal 20, a tapered slope 123 may be formed outside the safe band part 120 to prevent a mechanical force from being applied to the inner wall of the root canal 20 by the safe band part 120.

As described above, as the safe band part 120 is in contact with the inner wall of the root canal 20 to restrict the entry of the insertion part 110, it is possible to prevent the insertion part 110 from entering the root canal 20 deeper than the dentist intended.

The safe band part 120 according to another embodiment of the present disclosure may be slidably movable with respect to the insertion part 110. While the safe band part 120 is detachably coupled to the insertion part 110, the safe band part 120 may be slidably movable with respect to the insertion part 120.

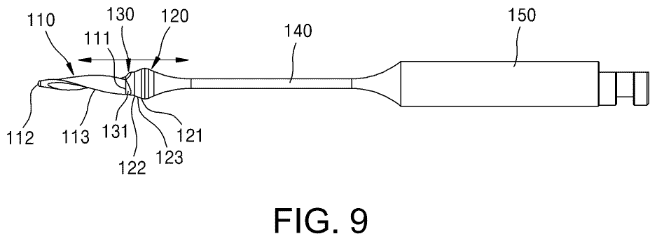

Referring to FIG. 9, the safe band part 120 may slidably move along the insertion part 110 according to a depth at which the insertion part 110 is inserted into the root canal 20. When the depth at which the insertion part 110 is inserted into the root canal 20 is short, the safe band part 120 may slidably move in the direction of the other end 112 of the insertion part 110 along the insertion part 110.

In addition, when the depth at which the insertion part 110 is inserted into the root canal 20 is long, the safe band part 120 may slidably move in the direction of the one end 111 of the insertion part 110 along the insertion part 110.

The safe band part 120 is not limited to slidable movement along the insertion part 110, and the safe band part 120 may slidably move along the extension part 140 provided at one side of the safe band part 120.

According to an embodiment of the present disclosure, the buffer part 130 together with the safe band part 120 may also slidably move with respect to the insertion part 110. According to an embodiment of the present disclosure, the safe band part 120 and the buffer part 130 may be integrally manufactured to slidably move with respect to the insertion part 110, and the safe band part 120 and the buffer part 130 may be manufactured to be separated from each other to slidably move with respect to the insertion part 110.

In order for the safe band part 120 and the buffer part 130 according to an embodiment of the present disclosure to slidably move with respect to the insertion part 110, various configurations may be provided in the safe band part 120 and the buffer part 130.

For example, the safe band part 120 and the buffer part 130 may be provided with a hollow into which the insertion part 110 is inserted, and the insertion part 110 may be press-fitted into the hollow. Through the hollow, the safe band part 120 and the buffer part 130 may slidably move with respect to the insertion part 110.

However, a method of allowing the safe band part 120 and the buffer part 130 to slidably move with respect to the insertion part 110 is not limited thereto, and various methods may be applied through various configurations.

The dental root canal treatment instrument according to the embodiment of the present disclosure described above has the following effects.

The dental root canal treatment instrument according to the embodiment of the present disclosure has the advantage of limiting the depth of entry of the insertion part entering the root canal by providing a safe band part on one side of the insertion part equipped with a clearing blade.

The dental root canal treatment instrument according to an embodiment of the present disclosure has the advantage of preventing the insertion part from entering the root canal deeper than the operator's intention by limiting the depth of entry of the insertion part through the safe band part.

The dental root canal treatment instrument according to an embodiment of the present disclosure has the advantage of increasing the efficiency of root canal treatment and increasing the success rate by preventing, through the safe band part, the insertion part from entering the root canal deeper than the operator's intention and failing the treatment.

As described above, the present disclosure has been described with reference to embodiments illustrated in the drawings, but these embodiments are only examples, and those skilled in the art will understand that various changes and modifications of the embodiments may be made therefrom. Therefore, the scope of true technical protection of the present disclosure should be determined by the technical idea of the appended claims.

What is claimed is:

1. A dental root canal treatment instrument used for root canal treatment by entering a root canal, the dental root canal treatment instrument comprising:
an insertion part extending in a longitudinal direction and being inserted into a root canal along with a clearing blade; and
a safe band part provided on one side of the insertion part, having a width greater than a width of the insertion part, and having no clearing blade, wherein the safe band part comes in contact with an inner wall of the root canal without cutting the root canal.

2. The dental root canal treatment instrument of claim 1, wherein a cross-section of the insertion part has a polygonal shape, and a cross-section of the safe band part has a circular shape.

3. The dental root canal treatment instrument of claim 1, wherein the insertion part and the safe band part are integrally manufactured.

4. The dental root canal treatment instrument of claim 1, wherein the insertion part and the safe band part include a same material and are integrally manufactured.

5. The dental root canal treatment instrument of claim 1, wherein the safe band part is slidably movable with respect to the insertion part.

6. The dental root canal treatment instrument of claim 1, wherein
the insertion part has a narrower width from one end to another end,
the safe band part has a width greater than a width of the one end of the insertion part, and
a tapered slope is formed outside the safe band part.

7. The dental root canal treatment instrument of claim 2, further comprising
a buffer part connecting the insertion part and the safe band part to each other,
wherein the buffer part comprises a cross-section part extending in a flat surface shape.

8. The dental root canal treatment instrument of claim 7, wherein
the insertion part, the safe band part, and the buffer part are integrally manufactured, and
the insertion part, the safe band part, and the buffer part are manufactured through laser processing.

9. The dental root canal treatment instrument of claim 1, further comprising:
an extension part provided at one side of the safe band part and extending in a longitudinal direction; and
a coupling part connected to the extension part and coupled to an electric device.
